(19) United States
(12) Patent Application Publication
(10) Pub. No.: US 2019/0034506 A1
(43) Pub. Date: Jan. 31, 2019

(54) GEOLOCATION PATTERN DETECTION AND INFORMATION SYNCHRONIZATION

(71) Applicants: Daniel Maxey Williford, Valencia, CA (US); Andrew Derek Law, West Hills, CA (US); Gary Stuart Mason, Simi Valley, VA (US)

(72) Inventors: Daniel Maxey Williford, Valencia, CA (US); Andrew Derek Law, West Hills, CA (US); Gary Stuart Mason, Simi Valley, VA (US)

(21) Appl. No.: 15/664,087

(22) Filed: Jul. 31, 2017

(51) Int. Cl. G06F 17/30; G06F 21/62; G06Q 30/00

(52) U.S. Cl. CPC G06F 17/30575; G06Q 30/01; G06F 17/30241; G06F 21/6245

(57) ABSTRACT

Geolocation data is analyzed for geolocation patterns relevant to personal information of a user that operates a device for which the geolocation data is associated with. The geolocation-determined personal information and other personal information are automatically synchronized and shared between the device and services of the user.

### BACKGROUND

Individuals are increasingly using a variety of networked-based service to conduct their affairs. This includes personal matters and business matters of the individuals. Network connectivity combined with miniaturization of computer-technology into mobile devices allow affairs to be conducted twenty-four hours a day and three-hundred and sixty-five days a year from nearly any location in which a network connection is available (e.g., Wi-Fi, cellular, Near-Field Communication (NFC), Radio Frequency (RF), satellite, Bluetooth®, etc.).

Furthermore, nearly every adult and most children have mobile phones with them at all times. This situation has presented enormous opportunities for businesses and there exists a plethora of business-based services offered in the industry to reach and establish close relationships with business customers while they are in possession of their mobile phones.

Customers are not static in nature and their lives, habits, personal information, and needs are continually changing. For example, customers get married and change their names, have or adopt children, experience death, move to a new home, change employment, encounter health or financial issues, change their phone numbers, change their email addresses, change business accounts, and the like. This makes it more difficult for businesses to establish relationships with the customers because information about the customers is continually evolving and changing, such that the customer information becomes stale and inapplicable to the customers. In fact, businesses often rely on their customers to update them when things have changed in their lives or changed with their personal information.

Some customers may want to update businesses with changed information but they may forget that they even have accounts with some business or may not know how to update those businesses. Other customers wish to control how much and when (if at all) businesses are updated with changed information (such as when the customers are concerned with their personal privacy).

However, in general, most customers find it difficult and burdensome to update all their known businesses when their customer information changes, especially when each business employs different communication channels and device interfaces for changing customer information (and in many cases the customers may have long sense forgotten their credentials for accessing such interfaces). Businesses also change their interfaces and access interfaces which may make previous mechanisms used by customers inapplicable after a period of transition.

These and other situations present a challenge to businesses and customers to stay synchronized with one another; adversely impacting, in some circumstances, both the businesses and the customers.

### SUMMARY

In various embodiments, methods and a system for geolocation pattern detection and information synchronization are presented.

According to an embodiment, a method for geolocation pattern detection and information synchronization is presented. More particularly, geolocations are obtained for a device operated by a user. An address is identified from the geolocations, and the address is mapped to information associated with the user. Finally, the address is synchronized on the device and with at least one external service associated with the user.

### BRIEF DESCRIPTION OF THE DRAWINGS

FIG. 1 is a diagram of a system for geolocation pattern detection and information synchronization, according to an example embodiment.

FIG. 2 is a diagram of a method for geolocation pattern detection and information synchronization, according to an example embodiment.

FIG. 3 is a diagram of another method for geolocation pattern detection and information synchronization, according to an example embodiment.

FIG. 4 is a diagram of another system for geolocation pattern detection and information synchronization, according to an example embodiment.

### DETAILED DESCRIPTION

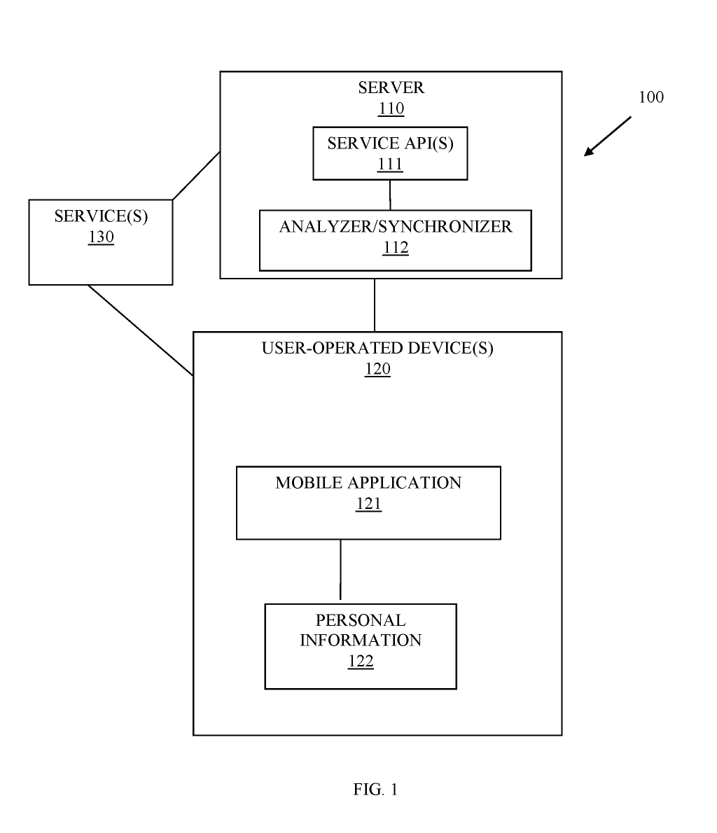

FIG. 1 is a diagram of a system 100 for geolocation pattern detection and information synchronization, according to an example embodiment. The various components are illustrated and the arrangement of the components is presented for purposes of illustration only. It is to be noted that other arrangements with more or less components are possible without departing from the geolocation pattern detection and information synchronization teachings presented herein and below.

The techniques, methods, and system presented herein and below for geolocation pattern detection and information synchronization can be implemented in whole or in part in one, all, or some combination of the components shown with the system 100. The techniques and methods are programmed as executable instructions in memory and/or non-transitory computer-readable storage media and processed on one or more processors associated with the various components.

The discussion of the system 100 is within the context of a customer of one or more businesses. It is noted that the system 100 is also applicable to any situation in which geolocation pattern detection and information synchronization is utilized. Thus, the description that follows below is but one embodiment of the invention and it not intended to limit the invention to only customer and business interactions.

As used herein the terms “customer,” “consumer,” and “user” may be used synonymously and interchangeably.

The term “geolocation” is a geographic location (position) or a geographical estimation of a physical location for a device being operated by or known to be in the possession of a user, at any given point in time.

The geolocation can be identified in a variety of known manners, such as through location services available on a user-operated device through Global Positioning Satellites (GPS), Wi-Fi, beacons, etc.

As used herein “personal information” refers to data that is unique to a user and which may or may not present privacy concerns for the user if used in an unauthorized manner by someone other than the user. By way of example only, personal information can include such things as: an email address, a user name, a home address, a work address, a birthdate, an employer of the user, financial information for the user, phone numbers, a salary, governmental identifying codes for the user, social media user identifiers, and the like.

The system 100 includes a server having service Application Programming Interfaces (APIs) 111 and an analyzer/synchronizer 112. The system 100 also includes one or more user-operated devices 120 (hereinafter referred to as “device 120”) having a mobile application 121 (herein after referred to as “app 121”) that controls personal information 122. The system 100 also interacts with one or more external services 130 through the APIs 111.

The app 121 includes a server-facing API for interacting with the server 110 over a network connection. The app 121 also includes processing for interaction with the device's location services for purposes of receiving a geolocation for the device 120. The app 121 is configured to periodically (at predefined intervals) to report geolocations received from the device's location services to the analyzer/synchronizer 112 using the server-facing API. This is done without user knowledge or input. In an embodiment, before the app 121 reports any geolocation for the device 120, a user-facing interface (or Operating System (OS) interface) of the device 120 presents a disclosure to the user operating the device 120 to obtain permission for reporting the geolocations from the user.

Also it is noted that the each report out to the analyzer/synchronizer 112 of a geolocation includes a device identifier (id) that uniquely identifies the device 120 and the id is associated with or linked to a registered user for the server 110. A single registered user can have multiple user-operated devices 120 associated with that user. Additionally, each geolocation reported by the app 120 includes a date and time for when that geolocation was obtained for the device 120.

The analyzer/synchronizer 112 receives the geolocations being reported from the app and links the geolocations to a geolocation history linked to the user. After a preconfigured amount of time from when the app 121 was first executed a first time on the device 120 (such as a week but can be shorter such as a day), the analyzer/synchronizer 112 processes the geolocation history to identify/detect geolocation patterns for the user's travel habits. This can be done in a variety of manners.

For example, the analyzer/synchronizer 112 can identify a frequency of repeating geolocations occurring during a same or substantially the same time period for the device 120. This can also include the user's patterns of travel from one geolocation to another geolocation during specific days of the weeks, days of a month, and/or times during the day. Also, a single geolocation can also be mapped to a calculated time spent at that geolocation by the device 120. These frequencies and times can be used to automatically and programmatically infer some personal information 122 about the user, such as the user's home address, the user's work address, a contact of the user's address, business addresses, venue addresses, etc.

In an embodiment, any machine learning process can also be processed against the geolocations for inferring some of the personal information 122 for the user (home address, work address, a contact of the user's address, business address, venue address, etc.) based on machine learning-determined geolocation patterns.

In addition to geolocation reporting by the app 121. The app 121 processes to monitor actions being taken by the user on the device 120 and accesses other application data (contacts data) and OS data housed for the user on the device 120, such as the user's name, the user's email addresses, the user's social media identifiers, the device's phone number (if it has one), phone numbers not associated with the device 120. The user-facing interface of the app 121 (or an OS interface of the device) also requests user permission for access to this OS or other app data (such as contacts data) on the device. This other information is copied and maintained in a secure file as the user's personal information 122 on the device 120 in a format that the app can process and retrieve. The app's server API is used to report this personal information 122 to the analyzer/synchronizer 112.

If any of the personal information 122 is changed or modified by the user during operation of the device 120, the user-facing interface of the app 121 presents an interface screen to the user indicating that the app noticed that a type of personal information 122 (name, address, contact, email, phone number) previously recorded by the app 121 has changed and asks permission from the user through the interface screen to update the personal information 122 being retained by the server 110 with the server 110 and on the device 120. The interface screen may also present an option for the app 121 to perform updates to the server 110 automatically without any such user interface screen on further changes detected to the personal information 122.

In this manner as personal information 122 changes for the user, the user is not forced to manually update changed personal information 122 with the user's services 130 (as discussed further below).

When the analyzer/synchronizer 112 has identified specific geolocations that are believed to be relevant to or a part of the user's personal information 122, the analyzer/synchronizer 112 processes an app API for interacting with the app 121 through the app's server API. The analyzer/synchronizer 112 instructs the app 121 to present a screen through the user-facing interface of the app 121 to the user indicating that a specific geolocation is believed to be a particular type of personal information 122 relevant to the user, such as home address, work address, contact's address. The user is asked to confirm or modify through the interface screen. And the personal information 122 is updated by the app 121 on the device and the analyzer/synchronizer 112 updates the personal information being maintained on the server 110 on behalf of the user. The identified geolocation patterns to infer a geolocation of relevancy to the personal information 122 may also be new, such that the interface screen presented to the user may include specific information and ask if the user wishes to add a new contact to the user's contact data in the personal information 122. For example, the interface screen may state “we noticed that every Tuesday evening at 8 pm you are visiting the venue named X, would you like to add a contact for X.

It is noted that the analyzer/synchronizer 112 is continually processing and attempting to identify new of changed geolocations that are relevant to the user's personal information 122. Thus, as conditions change for the user, the analyzer/synchronizer 112 provides a mechanism for automatically identifying changed or new personal information 122 for the user and interact with the user through the app 121 to assist the user in updating or creating new personal information 122. This is achieved through the detected geolocation patterns of the user based on movement and travel of the device 120, which is in the possession of the user and operated by the user.

The personal information 122 or user-defined and approved portions of the personal information 122 can also be shared by the user with one or more entities through the system 100 so as to allow services 130 of these entities to stay synchronized with the user's personal information 122. The analyzer/synchronizer 112 processes individual service APIs 111 for automatically keeping the personal information 122 of the user in synchronization with the user's services 130. The app 121 through the user-facing interface obtains pre-approval for the synchronization and sharing of specific user-approved portions of the user's personal information 122 from the user. This ensures that any synchronization and sharing of the personal information 122 is user authorized.

The service API's 111 also permit service-generated requests of actions to be reported to the user for authorization and modification. For example, suppose that the user is obtaining a loan for a car and the user's bank (service 130) needs to generate an employment verification letter, the bank 130 can send the request through the service APIs 111 requesting permission to user an employment address from the user's personal information 122. The analyzer/synchronizer 112 interacts with the app 121 and the app 121 presents an interface screen that indicates the bank 130 wants to use the employment address (for example, 6021 Lindero Way) can we provide that to the bank 130. This permits the user to obtain a faster loan approval and can be done in near real-time when the bank 130 needs the employment address. The actual personal information 122 being requested can be presented in the user interface screen for the user to view.

The app 121 through the user-facing interface can also present a variety of automatic configuration options to the user for each piece of unique personal information 122 (addresses, phone numbers, emails, names, contacts, etc.). For example, the user can indicate through a configuration screen to allow automatic synchronization and sharing with all user-known services 130 the user's home address, work address, personal email address, and cell phone number; but the user may request manually authorization for any service 130 requesting access to the user's home phone number and work email address. The user can access the configuration options at any point desired by the user so that the user can determined how to best maintained privacy while enjoying the benefits of automatic synchronization of some user-determined personal information 122.

In an embodiment, the app 121 is also configured to identify when the user is accessing a form within a browser application, etc. This can be achieved through plugins to device applications allowing the app 121 to be accessible while those device applications are executing. In these embodiments, the user can select the plugin for the app 121 within a device application (e.g., browser) for automatically populating personal information 122 to fields of the form.

An example processing scenario for the system 100 is now discussed. It is noted that the embodiments presented with this scenario is not intended to restrict the invention to just this particular embodiment, since it should be apparent to one of ordinary skill in the art that other scenarios are achievable through the beneficial teachings presented herein.

In the example, the user is referred to as Joe. Joe is located in Needles, Calif., near the state border. Joe recently changed his phone number and email address (personal information 122), moved to a new address, and has a phone (device 120) with an operational app 121 registered with server 110. Joe is in desperate need of a new work truck, but his business is in a down cycle. As a result, his mortgage payments are delinquent and he is having difficulty in staying current with his ongoing business expenses including: his legal requirements for his business, tax payments, and leased equipment. Occasionally, Joe also does business in Nevada as well as California. Joe could really benefit from having information that gives him: options regarding his mortgage delinquency, lease implications for nonpayment, tax payment restructuring, information to managing interstate commerce financial regulation compliance, and financial planning help. But, Joe is a proud man and a procrastinator so it is difficult for him to actually reach out and ask for help and it is easier for Joe to just ignore these things until they reach a crisis state for him.

If Joe lacked the app 121, Joe's financial institution is unable to quickly contact Joe through phone, email, or other communication channels. Joe would in this situation have his mortgage go into default/foreclosure, default on his equipment leases, fail to replace his truck, have the Interstate Commerce Commission (ICC) initiate imposition of fines, have the Internal Revenue Service (IRS) levy penalties for nonpayment of his taxes, and ultimately have his business fail. The financial institution also loses in this situation because Joe defaults on the loan, they lose a previously profitable customer, they lose an opportunity for future business with Joe, and they incur expenses due to processing the losses.

However, Joe has the app 121 so the financial institution reaches Joe through the service APIs 111 interfaced to the analyzer/synchronizer 112 and the app 121. As a result, Joe and the financial institution timely work together to cure the mortgage delinquency, obtain financial planning assistance, confirm to ICC regulatory compliance requirements, restructure the lease arrangements, and stay current on regulatory documents. Joe uses the app 121 to timely submit applications and forms to refinance the mortgage, stay current on regulatory notifications, and act in time to secure lease restructuring. Additionally, the financial institution is able to: retain the loan, assist a grateful customer (Joe) return to good standing, provide other more profitable solutions to Joe (lease refinancing, vehicle loans, etc.), avoid expenses from defaulting on the loan, chasing down Joe to get documentation that needs completed, and automatically stay current on compliance related documents. The result is a win-win for Joe and the financial institution.

The system 100 provides mechanisms for automatically discovering new and updating existing personal information 122 of a user that can be automatically synchronized and shared with a plurality of services 130 associated with the user. This also system 100 provides automatically geolocation pattern detection for at least some of the new or modified personal information 122. The personal information 122 can also be requested and processed through the services 130 that initiate the requests to the system 100.

In an embodiment, the device 110 is one of: a wearable processing device, a tablet, a phone, a computer-based device integrated into a transportation vehicle.

In an embodiment, the app 121 is a financial institution app for a financial service 130 of the user.

In an embodiment, the app 121 is a separate app 121 that is independent of any service 130 of the user.

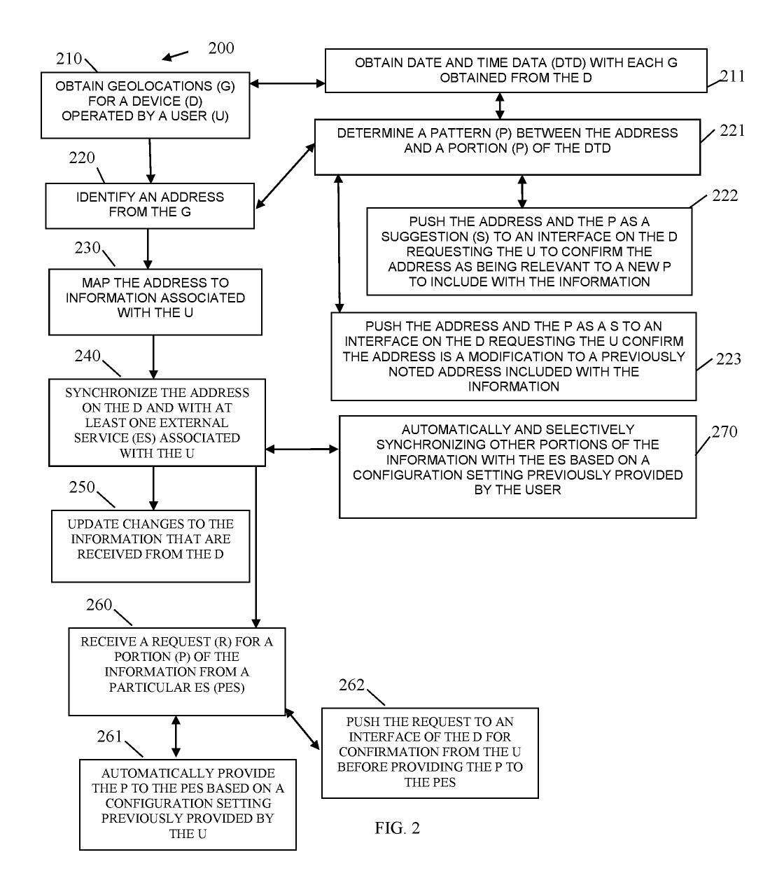

These embodiments and other embodiments are now discussed with reference to the FIGS. 2-4.

FIG. 2 is a diagram of a method 200 for geolocation pattern detection and information synchronization, according to an example embodiment. The software module(s) that implements the method 200 is referred to as a “geolocation analyzer/synchronizer.” The geolocation analyzer/synchronizer is implemented as executable instructions programmed and residing within memory and/or a non-transitory computer-readable (processor-readable) storage medium and executed by one or more processors of a device. The processor(s) of the device that executes the geolocation analyzer/synchronizer are specifically configured and programmed to process the geolocation analyzer/synchronizer. The geolocation analyzer/synchronizer has access to one or more networks during its processing. The networks can be wired, wireless, or a combination of wired and wireless.

In an embodiment, the geolocation analyzer/synchronizer is the geolocation analyzer/synchronizer 112 of the FIG. 1.

In an embodiment, the device that executes the geolocation analyzer/synchronizer is the server 110.

In an embodiment, the device that executes the geolocation analyzer/synchronizer is a plurality of servers logically organized as a cloud processing environment.

At 210, the geolocation analyzer/synchronizer obtains geolocations for a device that is operated by a user.

According to an embodiment, at 211, the geolocation analyzer/synchronizer obtains date and time data unique to each geolocation obtained from the device.

At 220, the geolocation analyzer/synchronizer identifies an address from the geolocations as being relevant to personal information or contact data associated with the user.

In an embodiment of 211 and 220, at 221, the geolocation analyzer/synchronizer determines a pattern between the address and a portion of the data and time data. This was discussed above with the discussion of the FIG. 1 and can be based on frequency of occurrence of the address within the geolocations and/or based on a length of time that the device remains at the address and times of day or days of week. This can also be achieved through machine learning services configured for detecting the pattern.

In an embodiment of 221 and at 222, the geolocation analyzer/synchronizer dynamically pushes the address as a suggestion to an interface on the device that requests the user to confirm the address as being relevant to a new portion of the personal information (such as a new contact) that was not previously present in the personal information.

In an embodiment of 221 and at 223, the geolocation analyzer/synchronizer pushes the address as a suggestion to an interface on the device that requests the user to confirm the address as a modification to a previously noted address included within the personal information (for example, a changed home or work address for the user).

At 230, the geolocation analyzer/synchronizer maps the address to personal information associated with the user and being maintained by the geolocation analyzer/synchronizer.

At 240, the geolocation analyzer/synchronizer synchronizes the address on the device and with at least one external service associated with the user. In an embodiment, the external service is the external service 130.

According to an embodiment, at 250, the geolocation analyzer/synchronizer updates changes to the personal information that are received from the device.

In an embodiment, at 260, the geolocation analyzer/synchronizer receives a request for a portion of the personal information from a particular external service associated with the user.

In an embodiment of 260 and at 261, the geolocation analyzer/synchronizer automatically provides the portion of the personal information to the particular external service based on a configuration setting previously provided by the user.

In an embodiment of 260 and at 262, the geolocation analyzer/synchronizer pushes the request to an interface of the device for confirmation from the user before the portion of the personal information is provided by the geolocation analyzer/synchronizer to the particular external service.

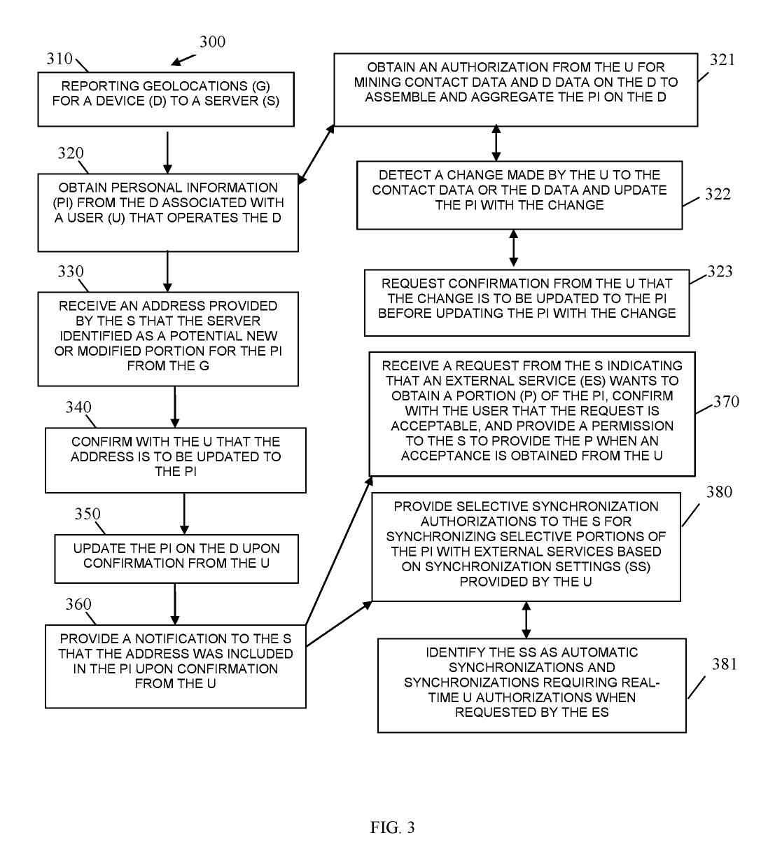

FIG. 3 is a diagram of another method 300 for geolocation pattern detection and information synchronization, according to an example embodiment. The software module(s) that implement the method 300 is referred to herein as a mobile application (mobile app). The mobile app is implemented as executable instructions and programmed within memory and/or a non-transitory computer-readable (processor-readable) storage medium that executes on one or more processors of a device. The processors of the device are specifically configured to execute the mobile app. The mobile app has access one or more networks; the networks can be wired, wireless, or a combination of wired and wireless.

The processing described herein for the mobile app interacts the method 200.

In an embodiment, the device that executes the mobile app is the device 120.

In an embodiment, the device that executes the mobile app is one of: a phone, a tablet, a wearable processing device, and a computing-enabled device integrated into a transportation vehicle.

At 310, the mobile app continuously and dynamically reports geolocations for a device operated by a user to a server. The geolocations are reported with unique dates and times for when each geolocation was obtained by the mobile app for the device. The mobile app executes on the device and can receive the geolocations from location-based services that processing within an Operating System (OS) of the device.

At 320, the mobile app obtains personal information from the device that is associated with the user.

According to an embodiment, at 321, the mobile app obtains an authorization from the user for mining contact data and device data on the device to assemble and aggregate the personal information on the device.

In an embodiment of 321 and at 322, the mobile app detects a change made by the user to the contact data or the device data and updates the personal information with the change.

In an embodiment of 322 and at 323, the mobile app requests confirmation from the user that the change is to be updated to the personal information before updating the personal information with the change.

At 330, the mobile app receives an address provided by the server that the server identified as a potential new or modified portion for the personal information from the geolocations.

At 340, the mobile app confirms with the user that the address is to be updated to the personal information.

At 350, the mobile app updates the personal information on the device upon confirmation from the user.

At 360, the mobile app provides a notification to the server that the address was included in the personal information upon confirmation from the user.

According to an embodiment, at 370, the mobile app receives a request from the server that indicates that an external service wants to obtain a portion of the personal information. In response, the mobile app confirms with the user that the request is acceptable and provides a permission to the server for providing the portion of the personal information when an acceptance is obtained from the user.

In an embodiment, at 380, the mobile app provides selective synchronization authorizations to the server for synchronizing selective portions of the personal information with external services based on synchronization settings provided by the user.

In an embodiment of 380 and at 381, the mobile app identifies the synchronization settings as automatic synchronizations (requiring no user confirmation) and synchronizations requiring real-time user authorizations when requested by the external services.

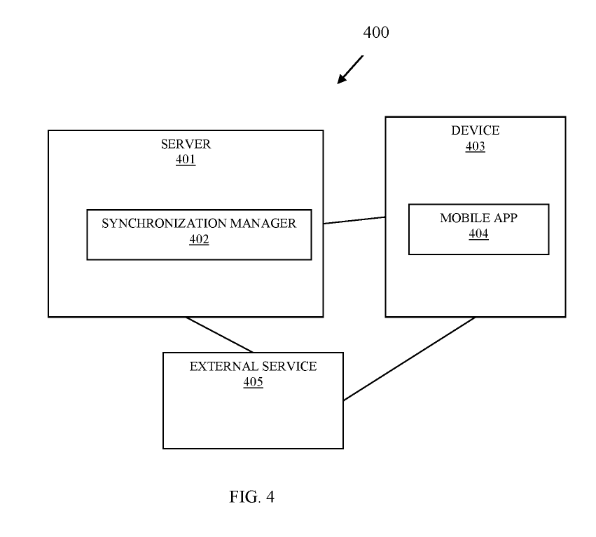

FIG. 4 is a diagram of a system 400 for geolocation pattern detection and information synchronization, according to an example embodiment. The components of the system 400 are programmed and reside within memory and/or a non-transitory computer-readable medium and execute on one or more processors of the devices of the system 400. The system 400 also has access and can communicate over one or more networks; and the networks can be wired, wireless, or a combination of wired and wireless.

The system 400 is configured and programmed to perform the processing discussed above with the FIGS. 1-3.

The system 400 includes a server 401 having a synchronization manager 402 and a device 403 having a mobile application 404. The system 400 also interacts with at least one external service 405 associated with a user that operates the device 403.

In an embodiment, the server is the server 110.

In an embodiment, the server is a part of a cloud processing environment.

In an embodiment, the device 403 is the device 120.

In an embodiment, the device 403 is one of: a wearable processing device, a tablet, a phone, and a computer-enabled device integrated into a transportation vehicle.

The mobile application 404 executes on the device 402 and is configured to: i) report geolocations for the device 403 to the synchronization manager 402 of the server 401 and ii) discover, update, and maintain personal information for a user on the device 403.

In an embodiment, the mobile application performs some or all of the processing discussed above for the app 121 and the method 300.

The synchronization manager 402 executes on the server 401 and is configured to: i) derive an address relevant to the personal information from the geolocations and ii) selectively synchronize the personal information with the mobile application 404 and at least one external service 405 associated with the user.

In an embodiment, the synchronization manager 402 performs some or all of the processing discussed above for the analyzer/synchronizer 112 and the method 200.

In an embodiment or the above-disclosed embodiments, the processing discussed above with respect to the server is subsumed and processed entirely within the mobile application.

In an embodiment of the above-disclosed embodiments, the processing discussed above with respect to the mobile application is subsumed and processed entirely on the server.

It should be appreciated that where software is described in a particular form (such as a component or module) this is merely to aid understanding and is not intended to limit how software that implements those functions may be architected or structured. For example, modules may be illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors of a single device, or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
obtaining geolocations for a device operated by a user;
identifying an address from the geolocations;
mapping the address to information associated with the user; and
synchronizing the address on the device and with at least one external service associated with the user.

2. The method of claim 1, wherein maintaining further includes obtaining date and time data with each geolocation obtained for the device.

3. The method of claim 2, wherein identifying further includes determining a pattern between the address and a portion of the data and time data.

4. The method of claim 3 further comprising, pushing the address and the portion as a suggestion to an interface on the device requesting the user to confirm the address as being relevant to a new portion to include with information.

5. The method of claim 3 further comprising, pushing the address and the portion as a suggestion to an interface on the device requesting the user confirm the address is a modification to a previously noted address included with the information.

6. The method of claim 1 further comprising, updating changes to the personal information that are received from the device.

7. The method of claim 1 further comprising, receiving a request for a portion of the information from a particular external service.

8. The method of claim 7, wherein receiving further includes automatically providing the portion to the particular external service based on a configuration setting previously provided by the user.

9. The method of claim 7, wherein receiving further includes pushing the request to an interface of the device for confirmation from the user before providing the portion to the particular external service.

10. The method of claim 1 further comprising, automatically and selectively synchronizing other portions of the information with the at least one external service based on a configuration setting previously provided by the user.

11. A method, comprising:
reporting geolocations for a device to a server;
obtaining personal information from the device associated with a user that operates the device;
receiving an address provided by the server that the server identified as a potential new or modified portion for the personal information from the geolocations;
confirming with the user that the address is to be updated to the personal information;
updating the personal information on the device upon confirmation from the user; and
providing a notification to the server that the address was included in the personal information upon confirmation from the user.

12. The method of claim 11, wherein obtaining further comprising obtaining an authorization from the user for mining contact data and device data on the device to assemble and aggregate the personal information on the device.

13. The method of claim 12, wherein obtaining further includes detecting a change made by the user to the contact data or the device data and updating the personal information with the change.

14. The method of claim 13, wherein detecting further includes requesting confirmation from the user that the change is to be updated to the personal information before updating the personal information with the change.

15. The method of claim 11 further comprising, receiving a request from the server indicating that an external service wants to obtain a portion of the personal information, confirming with the user that the request is acceptable, and providing a permission to the server to provide the portion when an acceptance is obtained from the user.

16. The method of claim 11 further comprising, continually executing the method while the device is in operation and online for use.

17. The method of claim 11 further comprising, providing selective synchronization authorizations to the server for synchronizing selective portions of the personal information with external services based on synchronization settings provided by the user.

18. The method of claim 17, wherein providing further includes identifying the synchronization settings as automatic synchronizations and synchronizations requiring real-time user authorizations when requested by the external services.

19. A system, comprising:
a sever that executes a synchronization manager; and
a device that executes a mobile application;
wherein the mobile application is configured to: i) report geolocations for the device to the synchronization manager and ii) discover, update, and maintain personal information for a user on the device, and wherein the synchronization manager is configured to: i) derive an address relevant to the personal information from the geolocations and ii) selectively synchronize the personal information with the mobile application and at least one external service associated with the user.

20. The system of claim 19, wherein the server is part of a cloud processing environment and the device is one of: a wearable processing device, a tablet, a phone, and a computer-enabled device integrated into a transportation vehicle.
